(19) United States
(12) Patent Application Publication
(10) Pub. No.: US 2005/0138029 A1
(43) Pub. Date: Jun. 23, 2005

(54) Generalized index set splitting in software loops

(75) Inventors: Robert James Blainey, Newmarket (CA); Arie Tal, Toronto (CA)

Correspondence Address: David R. Irvin;International Business Machines, T81/Bldg. 503, PO Box 12195, Research Triangle Park, NC, 27709, US

(73) Assignee: International Business Machines Corporation, Armonk, NY (US)

(21) Appl. No.: 10/864,257

(22) Filed: Jun. 9, 2004

(30) Foreign Application Priority Data
Dec. 19, 2003 (CA) 2,453,777

(51) Int. Cl. G06F 7/00

(52) U.S. Cl. 707/6

(57) ABSTRACT

There is disclosed a method and system for determining the bounds of generated software loops, where the relationships between split points and loop bounds are not known, or only partly known, at compile time. A “sub-range tree” is built with a root node representing the original software loop. Each sub-node represents a sub-range of the original software loop split by one or more split points. Each edge between nodes of the sub-range tree is marked with either a “then” (T) or “else” (E) marker, according to a predetermined scheme. Once the sub-range tree is built, a “path-from-root” is analyzed for each leaf node of the sub-range tree, and “dead” inductive control flow branches are identified and folded. The growth of software loop code based on the sub-range tree may be restricted by a predetermined code growth limit.

### BACKGROUND OF THE INVENTION

The present invention relates generally to data processing systems and software programs, and in particular to a method and system for determining the bounds of generated software loops where the relationships between split points and the loop bounds are not known, or only partially known, at compile time.

“Index set splitting” is a loop transformation that divides a loop's index range into a collection of sub-ranges. In particular, index set splitting may be applied to “normalized” loops that have an iteration increment of 1. (As known in the art, loop “normalization” is a transformation that identifies inductive variables in a loop and converts them into a linear functions of a single induction variable, which starts from 0 and “bumps” by 1 on every iteration. The loop bounds are adjusted accordingly.)

For example, when splitting an index set into two sub-ranges, a lower bound (LB), split point (SP), and upper bound (UB) are defined. (In this description, these acronyms SP, LB and UB, are used interchangeably with their original long form depending on context, and for the sake of clarity.) Each sub-range, separated at the split point, is then handled as a separate loop, potentially enabling the folding of “dead” inductive control flow branches of the original loop (i.e. control flow branches within the original loop that become always true or always false).

This may create opportunities for parallelization (by making loops independent), and further code optimization.

When the relationships between a SP, LB and UB are known at compile time, it is easy to determine the appropriate sub-ranges.

By way of illustration, consider the following code:

```
do i=1, 100
  if (i < 5) then
    a[i] = 2*a[i]
  else
    a[i] = 5*a[i]
  end if
end do
```

In this illustrative example, the LB is 1, the UB is 100 and the SP is 5. Thus, the appropriate sub-ranges will be 1 . . . 4 and 5 . . . 100 (here, the split point is defined as the first point above the lower sub-range of 1 . . . 4). The index set splitting transformation will generate the two following loops:

```
do i=1, 4
  if (i < 5) then
    a[i] = 2*a[i]
  else
    a[i] = 5*a[i]
  end if
end do
do i=5, 100
  if (i < 5) then
    a[i] = 2*a[i]
  else
    a[i] = 5*a[i]
  end if
end do
```

Since the first loop, above, only iterates on the 1 . . . 4 sub-range, the inductive condition “if (i<5)” in that loop will always be true. Similarly, in the second loop, above, the inductive condition “if (i<5)” will always be false. These “dead” inductive control flow branches can be folded, and the resulting code will be:

```
do i=1, 4
  a[i] = 2*a[i]
end do
do i=5, 100
  a[i] = 5*a[i]
end do
```

As will be appreciated by those skilled in the art, the situation becomes significantly more complex when the split point is an arbitrary one, and the relationships between split points and loop bounds are not known, or only partially known, at compile time. What is needed is a generalized method and system for handling such cases.

### SUMMARY OF THE INVENTION

There is provided a method and system for determining the bounds of generated software loops, where the relationships between split points and loop bounds are not known, or only partly known, at compile time.

A “sub-range tree” is built to map out possible inductive paths for split points and loop bounds unknown at compile time. Each sub-range tree has a root node representing an original software loop. Each second level node represents a sub-range of the original software loop split by a first split point. Each third level node, if any, represents a further sub-range of each sub-range in the second level split by a second split point, and so on. Each edge between nodes of the sub-range tree is marked with either a “then” (T) or “else” (E) inductive control flow branch marker, according to a predetermined scheme. Once the sub-range tree is built, a “path-from-root” may be analyzed for each leaf node of the sub-range tree. Based on this path-from-root analysis, “dead” inductive control flow branches are identified and folded. (In the present description, an “inductive control flow branch” refers to control flow within a loop and is not to be confused with a “branch” of the sub-range tree. The sub-range tree in the present description has “edges” between nodes rather than “branches”.) Advantageously, folding of these dead inductive control flow branches may create opportunities for parallelization through independent loops, and further code optimization.

In an embodiment, the growth of software loop code based on a sub-range tree may be restricted by a predetermined code growth limit. In enforcing the code growth limit, the sub-range tree is traversed in a “greedy breadth-first” like manner, starting at the root, and stopping when the leaves of the tree are reached. (As known in the art, a “greedy breadth-first” manner generally favors covering breadth over depth.) This control over growth of the sub-range tree may allow the number of generated loops, and the corresponding size of the resulting generated code, to be limited when desired.

In an aspect of the invention, there is provided a method of determining the sub-range bounds of a software loop having a lower bound (LB), an upper bound (UB), and a split point (SP) associated with an inductive control flow branch and a condition operator, the method comprising:
(i) defining, in dependence upon the condition operator, a lower sub-range (LSR) as a function of LB, UB and SP;
(ii) if the condition operator is one of an equality operator (==) or a non-equality operator (!=), then defining an equality sub-range (ESR) as a function of LB, UB and SP;
(iii) defining, in dependence upon the condition operator, an upper sub-range (USR) as a function of LB, UB and SP.

In an embodiment, the method further comprises logically representing the software loop as a node of a sub-range tree having a range LB . . . UB, and logically representing LSR, ESR if any, and USR, as descendant nodes attached by edges to the root node.

In an embodiment, one of a “then” (T) and an “else” (E) marker is used to logically mark each edge, and the SP is adjusted, according to the following:

| Condition | Split Point | Then (T)/Else (E) |
|---|---|---|
| Operator | Adjustment | Ordering |
| i < SP | SP | T, E |
| i <= SP | SP + 1 | T, E |
| i > SP | SP + 1 | E, T |
| i >= SP | SP | E, T |
| i == SP | SP | E, T, E |
| i != SP | SP | T, E, T |

where i is an induction variable of the software loop.

In an embodiment, the method further comprises:
(iv) analyzing a path-from-root for each leaf node of the sub-range tree to determine whether an inductive control flow branch is always true or always false;
(v) for each node in (iv) determined as having an inductive control flow branch that is always true or always false, folding the inductive control flow branch.

In an embodiment, the method further comprises generating sub-range loop code for sub-ranges represented by remaining leaf nodes of the sub-range tree.

In an embodiment, the method further comprises controlling growth of the sub-range loop code by applying a predetermined sub-range loop code growth limit to each node of the sub-range tree.

In an embodiment, the predetermined sub-range loop code growth limit is a code size estimated as the amount of memory consumed by the code during execution.

In an embodiment each node of the sub-range tree is generally defined by the following expression:
L=(LB′, UB′, ((LB′, min (SPj-1, UB′), ( . . . )), (max (SPj, LB′), UB′, ( . . . ))))
   where SPj is a split point j, LB′ and UB′ are a lower bound and upper bound for a particular sub-range represented by node L, (LB′, min (SPj, UB′), ( . . . )) represents a first sub-range expressed by LB′, UB′ and SPj, (max (SPj, LB′), UB′, ( . . . )) represents a second sub-range represented by LB′, UB′ and SPj, and the brackets ( . . . ) represent zero or more descendant sub-nodes.

In another aspect of the invention, there is provided a system for determining the sub-range bounds of a software loop having a lower bound (LB), an upper bound (UB), and a split point (SP) associated with an inductive control flow branch and a condition operator, the system comprising:
(a) means for defining, in dependence upon the condition operator, a lower sub-range (LSR) as a function of LB, UB and SP;
(b) means for defining, if the condition operator is one of an equality operator (==) or a non-equality operator (!=), an equality sub-range (ESR) as a function of LB, UB and SP;
(c) means for defining, in dependence upon the condition operator, an upper sub-range (USR) as a function of LB, UB and SP.

In an embodiment, the system further comprises means for logically representing the software loop as a node of a sub-range tree having a range LB . . . UB, and logically representing LSR, ESR if any, and USR, as descendant nodes attached by edges to the root node.

In an embodiment, the system further comprises means for logically marking one of a “then” (T) and an “else” (E) marker on each edge, and for adjusting the SP, according to the following:

| Condition | Split Point | Then (T)/Else (E) |
|---|---|---|
| Operator | Adjustment | Ordering |
| i < SP | SP | T, E |
| i <= SP | SP + 1 | T, E |
| i > SP | SP + 1 | E, T |
| i >= SP | SP | E, T |
| i == SP | SP | E, T, E |
| i != SP | SP | T, E, T |

where i is an induction variable of the software loop.

In an embodiment, the system further comprises:
(d) means for analyzing a path-from-root for each leaf node of the sub-range tree to determine whether an inductive control flow branch is always true or always false;
(e) means for folding an inductive control flow branch determined in (d) as being always true or always false.

In an embodiment, the system further comprises means for generating sub-range loop code for sub-ranges represented by remaining leaf nodes of the sub-range tree.

In an embodiment, the system further comprises means for controlling growth of the sub-range loop code by applying a predetermined sub-range loop code growth limit to each node of the sub-range tree.

In an embodiment, the predetermined sub-range loop code growth limit is a code size estimated as the amount of memory consumed by the code during execution.

In an embodiment, the system includes means for defining each leaf node of the sub-range tree by the following expression:
L=(LB′, UB′, ((LB′, min (SPj-1, UB′), ( . . . )), (max (SPj, LB′), UB′,( . . . ))))
   where SPj is a split point j, LB′ and UB′ are a lower bound and upper bound for a particular sub-range represented by node L, (LB′, min (SPj, UB′), ( . . . )) represents a first sub-range expressed by LB′, UB′ and SPj, (max (SPj, LB′), UB′, ( . . . )) represents a second sub-range represented by LB′, UB′ and SPj, and the brackets ( . . . ) represent zero or more descendant sub-nodes.

In another aspect of the invention, there is provided a computer readable medium storing computer executable code for determining the sub-range bounds of a software loop having a lower bound (LB), an upper bound (UB), and a split point (SP) associated with an inductive control flow branch and a condition operator, the computer executable code comprising:
(a) code for defining, in dependence upon the condition operator, a lower sub-range (LSR) as a function of LB, UB and SP;
(b) code for determining if the condition operator is one of an equality operator (==) or a non-equality operator (!=), and if so, for defining an equality sub-range (ESR) as a function of LB, UB and SP;
(c) code for defining, in dependence upon the condition operator, an upper sub-range (USR) as a function of LB, UB and SP.

In an embodiment, the computer executable code further comprises code for logically representing the software loop as a node of a sub-range tree having a range LB . . . UB, and logically representing LSR, ESR if any, and USR, as descendant nodes attached by edges to the root node.

In an embodiment, the computer executable code further comprises code for logically marking one of a “then” (T) and an “else” (E) marker on each edge, and for adjusting the SP, according to the following:

| Condition | Split Point | Then (T)/Else (E) |
|---|---|---|
| Operator | Adjustment | Ordering |
| i < SP | SP | T, E |
| i <= SP | SP + 1 | T, E |
| i > SP | SP + 1 | E, T |
| i >= SP | SP | E, T |
| i == SP | SP | E, T, E |
| i != SP | SP | T, E, T |

where i is an induction variable of the software loop.

In an embodiment, the computer executable code further comprises:
(d) code for analyzing a path-from-root for each leaf node of the sub-range tree to determine whether an inductive control flow branch is always true or always false;
(e) code for folding an inductive control flow branch determined in (d) as being always true or always false.

In an embodiment, the computer executable code further comprises code for generating sub-range loop code for sub-ranges represented by remaining leaf nodes of the sub-range tree.

In an embodiment, the computer executable code further comprises code for controlling growth of the sub-range loop code by applying a predetermined sub-range loop code growth limit to each node of the sub-range tree.

In an embodiment, the predetermined sub-range loop code growth limit is a code size estimated as the amount of memory consumed by the code during execution.

In an embodiment, the computer executable code further includes code for defining each leaf node of the sub-range tree by the following expression:
L=(LB′, UB′, ((LB′, min (SPj-1, UB′), ( . . . )), (max (SPj, LB′), UB′, ( . . . ))))
   where SPj is a split point j, LB′ and UB′ are a lower bound and upper bound for a particular sub-range represented by node L, (LB′, min (SPj, UB′), ( . . . )) represents a first sub-range expressed by LB′, UB′ and SPj, (max (SPj, LB′), UB′, ( . . . )) represents a second sub-range represented by LB′, UB′ and SPj, and the brackets ( . . . ) represent zero or more descendant sub-nodes.

These and other aspects of the invention will be apparent from the following more particular descriptions of exemplary embodiments of the invention.

### BRIEF DESCRIPTION OF THE DRAWINGS

In the Figures which illustrate exemplary embodiments of the invention:

FIG. 1 is a schematic block diagram of a data processing system which may provide an operating environment for practicing exemplary embodiments of the invention.

FIGS. 2A and 2B illustrate a sub-range tree for one split point.

FIG. 2C is a schematic representation of the sub-range tree of FIG. 2B, expressed generally.

FIG. 3 is a schematic flow chart of a method in accordance with an embodiment of the invention.

FIG. 4 is a schematic flow chart of another method for handling equality split points, in accordance with an embodiment of the invention.

FIG. 5 is a schematic flow chart of another method for generally defining a sub-range tree with one or more split points.

FIGS. 6A-6C schematically illustrate growth of a sub-range tree for two split points.

FIG. 7 is an illustrative example of folding of a dead inductive control flow branch.

FIG. 8A-8C schematically illustrate controlled growth of a sub-range tree for two split points.

### DETAILED DESCRIPTION OF EXEMPLARY EMBODIMENTS

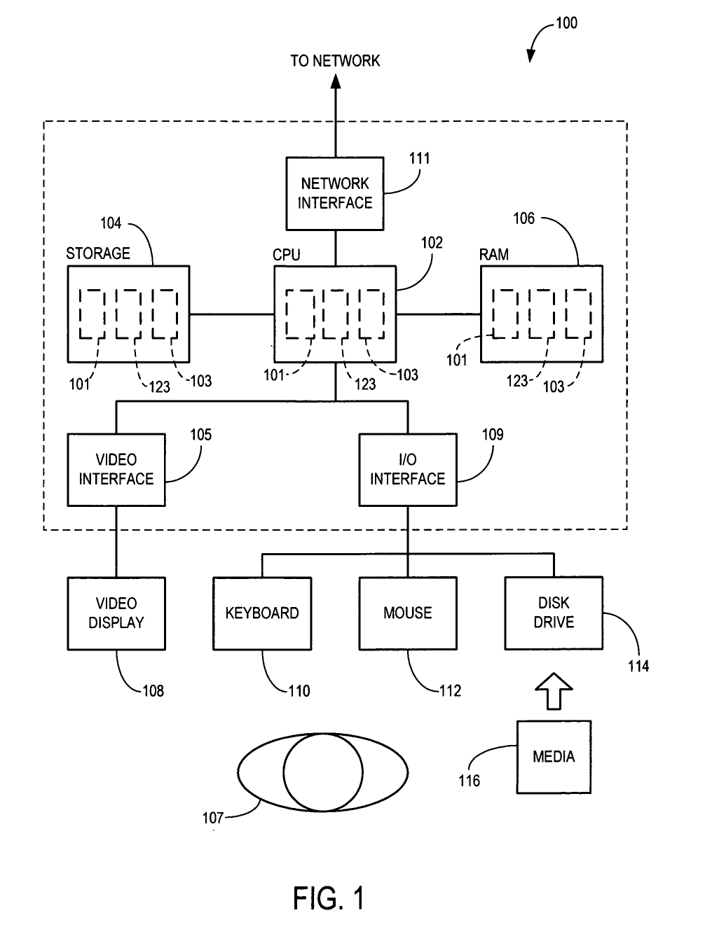

FIG. 1 shows an illustrative data processing system 100 that may provide an operating environment for exemplary embodiments of the invention. The data processing system 100 may include a central processing unit (“CPU”) 102 connected to a storage unit 104 and to a random access memory (“RAM”) 106. The CPU 102 may process an operating system 101, and a software program 103 compiled by a software program code compiler 123. The operating system 101, software program code compiler 123 and the software program 103 may be stored in the storage unit 104 and loaded into RAM 106, as required. A user 107 may interact with the data processing system 100 using a video display 108 connected by a video interface 105, and various input/output devices such as a keyboard 110, mouse 112, and disk drive 114 connected by an I/O interface 109. The disk drive 114 may be configured to accept computer readable media 116. Optionally, the data processing system 100 may be network enabled via a network interface 111. It will be appreciated that the data processing system 100 of FIG. 1 is merely illustrative and is not meant to be limiting in terms of the type of system that might provide a suitable operating environment for the invention.

The data processing system 100 of FIG. 1 may be used to run a software program 103 that comprises a software loop. By way of illustration, consider the software loop code previously introduced above:

```
do i=1, 100
  if (i < 5) then
    a[i] = 2*a[i]
  else
    a[i] = 5*a[i]
  end if
end do
```

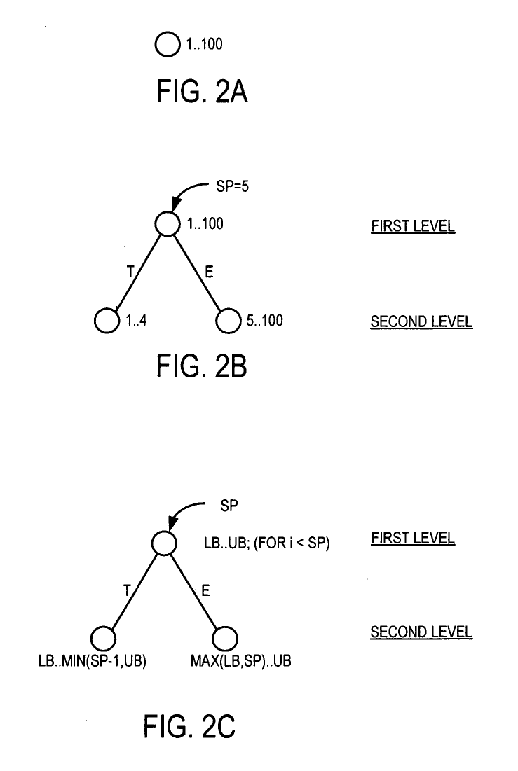

In accordance with an embodiment of the invention, the above software loop is represented as a root node, as shown in FIG. 2A. The two sub-ranges in the above software loop code (i.e., 1 . . . 4 and 5 . . . 100) may then be represented schematically as second level nodes in a sub-range tree, as shown in FIG. 2B. Using variables to generally represent the LB, UB, and SP, the two sub-ranges in the above software loop may be defined as follows:
lower sub-range (LSR)=LB . . . min (SP-1,UB) [1]
upper sub-range (USR)=max (SP,LB) . . . UB [2]
Here, the min( ) and max( ) functions, which output the minimum and the maximum, respectively, of any values within the brackets “( )”, address the possibility that SP may be less than LB, or greater than UB.

Thus, the software loop code shown above may be generalized as follows:

```
do i=LB, UB
  if (i < SP) then
    a[i] = 2*a[i]
  else
    a[i] = 5*a[i]
  end if
end do
```

Applying the above definitions [1] and [2], the software loop may be transformed into its sub-ranges, as follows:

```
do i=LB, min(SP−1, UB)
  if (i < SP) then
    a[i] = 2*a[i]
  else
    a[i] = 5*a[i]
  end if
end do
do i=max(LB,SP), UB
  if (i < SP) then
    a[i] = 2*a[i]
  else
    a[i] = 5*a[i]
  end if
end do
```

The corresponding general form of the sub-range tree is shown in FIG. 2C.

Even though the relationships between the split point and the loop bounds are not known at compile time, after the above transformation, it can be seen that the inductive condition “if (i<SP)” in the first loop will always be true, since the induction variable “i” will be smaller or equal to SP-1. Similarly, the inductive condition “if (i<SP)” in the second loop is always false, since the lower bound in the second loop determines “i” to be at least equal to the split point. Therefore, the inductive condition “if (i<SP)” is foldable in both loops, and the resulting code after “dead” inductive control flow branch folding would be as follows:

```
do i=LB, min(SP−1,UB)
  a[i] = 2*a[i]
end do
do i=max(LB,SP), UB
  a[i] = 5*a[i]
end do
```

To confirm that the new bound definitions for the sub-ranges as presented above are correct, consider the three possibilities for the SP in this case:
SP<=LB:
   In this case, LSR=LB . . . min (SP-1,UB), which is an empty range, and USR=max (SP,LB) . . . UB=LB . . . UB, which is equal to the original range. Therefore, the first generated loop will not execute, and the second loop will iterate through the entire index range.
SP>UB:
   In this case, USR=max (SP,LB) . . . UB, which is an empty range, and LSR=LB . . . min (SP-1,UB)=LB . . . UB, which is equal to the original range. Therefore, the first generated loop will iterate through the entire index range and the second loop will not execute.
LB<SP<=UB:
   In this case, LSR=LB . . . min (SP-1,UB)=LB . . . SP-1, and USR=max (SP,LB) . . . UB=SP . . . UB. Therefore, the first loop will iterate through the sub-range from lower bound up to the split point, and the second loop will iterate through the sub-range from the split point to the upper bound.
      In all of the above cases, if UB <LB, then neither the original loop nor the generated loops will execute.

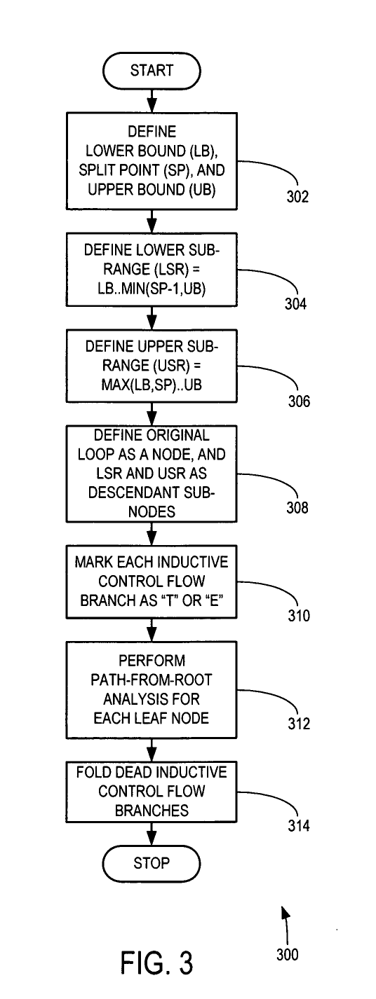

The above described process for generating a sub-range tree and removing dead inductive control flow branches, in the case where there is a singe SP at a less than (“<”) operator, may be summarized as shown in FIG. 3. More specifically, at block 302 of process 300, each of a lower bound (LB), split point (SP), and upper bound (UB) are defined. At block 304, a lower sub-range is defined in terms of a range, from the LB, to a minimum of SP-1 and the UB, or “LB . . . min (SP-1,UB)”. At block 306, the upper sub-range is defined in terms of a range from the maximum of LB and SP, to the UB, or “max (LB,SP) . . . UB”. Process 300 then proceeds to block 308, at which the original loop is logically defined as a root node, and each of the LSR and USR is defined as a descendant sub-node attached to the root node by an edge. Method 300 then proceeds to block 310, where each edge between nodes of the sub-range tree are marked with either a “then” (T) or an “else” (E) inductive marker, as shown in FIG. 2C. Process 300 then proceeds to block 312, where a “path-from-root” analysis is performed for each leaf node. Based on this analysis, at block 314, any dead inductive control flow branches in each loop are identified and folded. Process 300 then ends. Process 300 is generally applicable to any loop having a lower bound, upper bound, and a single split point at a less than (“<”) operator.

Equality Split Points

Split points due to equality condition operators require special consideration. These split points divide the iteration space into three parts instead of two (any of which may result in an empty sub-range, if the split point is above or below the upper bound or lower bound respectively). The three parts are:
The sub-range below the equality.
The single-iteration sub-range of the equality itself.
The sub-range above the equality.

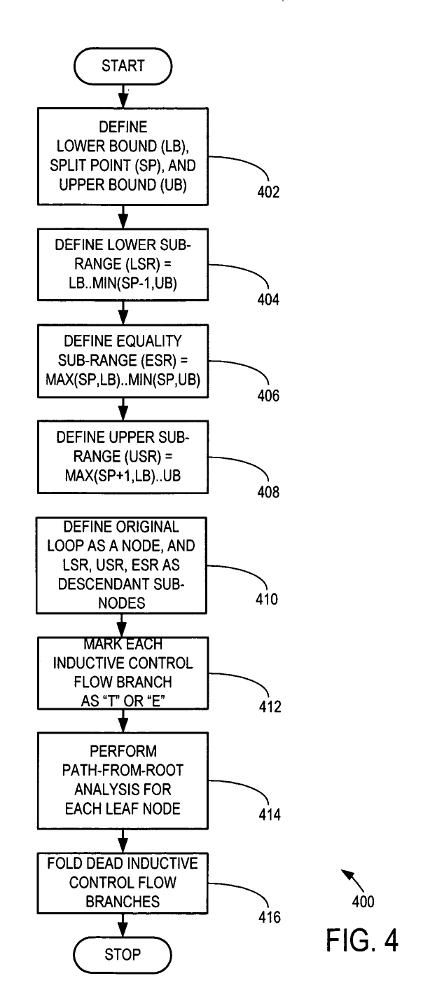

An illustrative process 400 for handling equality split points is shown in FIG. 4. By way of illustration, consider the following code containing an equality condition operator:

```
do i=1, 100
  if (i = 5) then
    a[i] = 2*a[i]
  else
    a[i] = 5*a[i]
  end if
end do
```

Given LB, UB and SP, as defined at block 402, the sub-ranges may be defined, in blocks 404, 406 and 408 respectively, as follows:
lower sub-range (LSR)=LB . . min (SP-1,UB) [3]
equality sub-range (ESR)=max (SP,LB) . . . min (SP,UB) [4]
upper sub-range (USR)=max (SP+1,LB) . . . UB [5]
By way of illustration consider a specific example where LB=1, SP=5, and UB=100. At block 410, applying [3], [4] and [5], process 400 transforms the original loop into three sub-ranges, as follows:
LSR=1 . . . min (5-1,100)=1 . . . 4
ESR=max (1,5) . . . min (5,100)=5 . . . 5
USR=max (5+1,1) . . . 100=6 . . . 100

The resulting code will contain three loops, as follows:

```
do i=1, 4
  if (i = 5) then
    a[i] = 2*a[i]
  else
    a[i] = 5*a[i]
  end if
end do
do i=5, 5
  if (i = 5) then
    a[i] = 2*a[i]
  else
    a[i] = 5*a[i]
  end if
end do
do i=6, 100
  if (i = 5) then
    a[i] = 2*a[i]
  else
    a[i] = 5*a[i]
  end if
end do
```

After marking each edge between nodes of the sub-range tree as a “T” or an “E” at block 412, performing a “path-from-root” analysis for each leaf node of the sub-range tree at block 414, and removing dead inductive control flow branches at block 416, the resulting code is as follows:

```
do i=1, 4
  a[i] = 5*a[i]
end do
do i=5, 5
  a[i] = 2*a[i]
end do
do i=6, 100
  a[i] = 5*a[i]
end do
```

Finally, after applying a commonly known loop elimination transformation, the middle loop control structure may be eliminated, and the resulting code is as follows:

do i=1, 4

a[i] = 5*a[i]

end do
a[5] = 2*a[5]
do i=6, 100

a[i] = 5*a[i]

end do

Process 400, then ends. Following a similar analysis, it can be shown that the same sub-range division holds for the “not equals” relationship as well (i.e. if “i !=5”).

The general process has been described by way of illustration with reference to FIG. 3 and FIG. 4. Details on how the bounds of each sub-range is determined, and how each edge of the sub-range graph is marked with either a “then” (T) or “else” (E) inductive control flow branch marker will now be described.

Inductive Control Flow Branch Condition Operators

As will be appreciated, the computation of the split point (SP) may be affected by the presence of different condition operators. For each condition operator, the following Table A summarizes the values of a split point (SP), and the order in which the “then” (T) and “else” (E) paths are executed relative to the index space order:

TABLE A

| Condition | Split Point | Then (T)/Else (E) |
|---|---|---|
| Operator | Adjustment | Ordering |
| i < SP | SP | T, E |
| i <= SP | SP + 1 | T, E |
| i > SP | SP + 1 | E, T |
| i >= SP | SP | E, T |
| i == SP | SP | E, T, E |
| i != SP | SP | T, E, T |

In Table A, above, the split point (SP) is initially calculated as the first point above the lower sub-range.

For the i<SP case, the initial SP value is used above in definitions [1] and [2], for LSR and USR respectively. However, for the i<=SP case, and for the i>SP case, it is seen that there is a split point “adjustment”, where the value SP is increased by one (i.e. SP+1). Thus, for the case i<=SP, and for the case i>SP, the SP value in definitions [1] and [2] is increased by one. In contrast, for the case i>=SP, there is no SP adjustment.

Similarly, for either the i==SP case, or the i!=SP case, the value of SP (i.e. as used above in definitions [3], [4] and [5], for LSR, ESR, and USR respectively) remains the same, and there is no adjustment.

The then (T)/else (E) ordering means that, for example, if the condition is i<SP, then the “then” part (i.e. when the condition succeeds) is executed first, since the lower values of “i” appear before the upper values of “i” (assuming a normal ordering). Conversely, if the condition is i>=SP, then the “else” part (i.e. where the condition fails) will be executed first. In the special cases of the “==” (“equal to”) and “!=” (“not equal to”) condition operators, one of the “then” (T) and “else” (E) parts is executed both before and after the equality/non-equality, which is consistent with the division of the range into three sub-ranges in these cases. An illustrative example of application of Table A is provided further below, using a multiple split point example (it will be appreciated however that Table A is equally applicable to a single split point situation).

Multiple Split Points

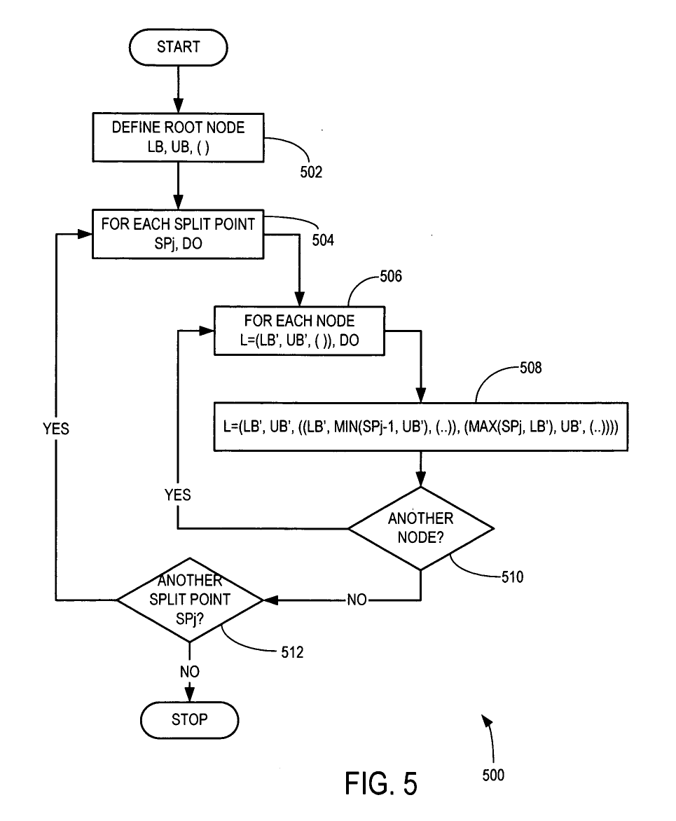

The description has so far considered a single split point, separating a lower sub-range and an upper sub-range. However, as will now be explained, multiple split points may be supported as well. Given a plurality of split points, the process of constructing an appropriate sub-range tree may be illustrated schematically, as shown in FIG. 5.

Method 500 is a simplification of one possible embodiment and begins by defining a root node, at block 502. Here, the root node indicates a lower bound, upper bound, and an initially unknown number of split points. Method 500 then proceeds to block 504, which forms a conditional loop with decision block 512. As shown, the condition at decision block 512 is whether there is another split point “SPj”. From block 504, method 500 proceeds to block 506, which forms a conditional loop with decision block 510. The condition at decision block 510 is whether there is another node L in the sub-range tree. For each node L, method 500 repeats block 508, where L is generally defined as follows:
L=(LB′, UB′, ((LB′, min (SPj-1, UB′), ( . . . )), (max (SPj, LB′), UB′, ( . . . )))) [6]

In definition [6] above, each node L is expressed as a “3-nary” object of (LB′, UB′, ( . . . )), where LB is the lower bound expression for node L, UB is the upper bound expression for node L, and ( . . . ) is a list of zero or more descendant sub-nodes. In an embodiment, an empty bracket ( ) may be used to denote zero sub-nodes, indicating that L is a leaf node. Otherwise, the elements inside a non-empty bracket ( . . . ) will be other descendant leaf nodes or sub-nodes. SPj represents a split point “j”. [LB′, min (SPj-1, UB′), ( )] represents a first sub-range expressed by LB′, UB′ and SPj. [max (SPj, LB′), UB′, ( )] represents a second sub-range represented by LB′, UB′ and SPj. Here, each split point “j” will occupy one level of the resulting sub-range tree, as will be illustrated.

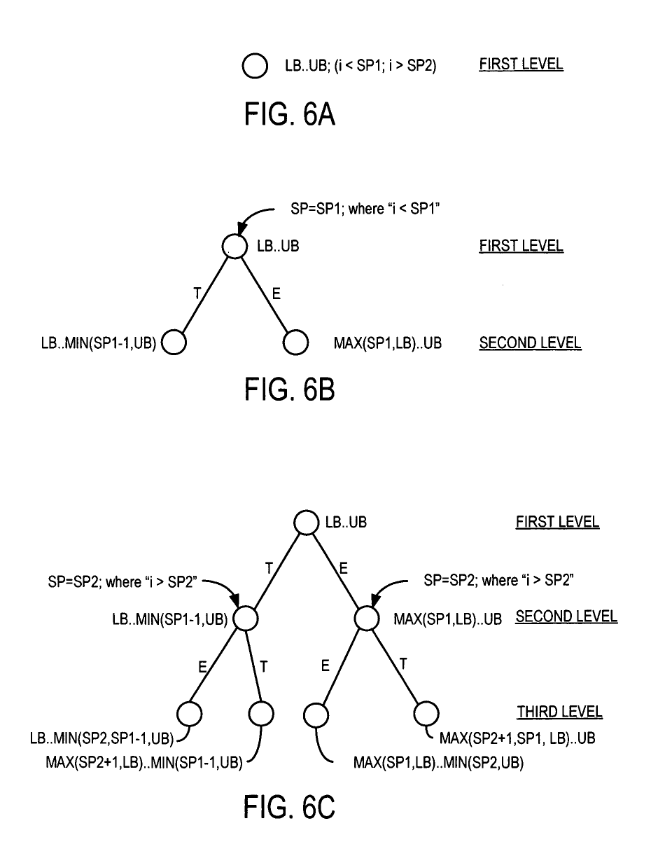

Following method 500, above, a sub-range tree may be built as shown by way of example in FIGS. 6A-6C. FIG. 6A represents an original loop, having a range from LB to UB, and first and second split points SP1 and SP2. In FIG. 6B, the nodes at the second level of the sub-range tree correspond to a lower sub-range (LSR) and an upper sub-range (USR), split at the first split point SP1. Here, as an illustrative example, the condition operator is in the form “i<SP1”. Thus, based on Table A, for the case of “i<SP1”, [1] and [2] become:
lower sub-range (LSR)=LB . . . min (SP1-1,UB) [7]
upper sub-range (USR)=max (SP1,LB) . . . UB [8]
Furthermore, based on Table A, the left edge is marked as a “then” (T) case, and the right edge is marked as an “else” (E) case.

In a corresponding manner, in FIG. 6C, the nodes at the third level of the sub-range tree correspond to further sub-ranges caused by a split at a second split point SP2. Here, as an illustrative example, the condition operator for the second split point is in the form “i>SP2”. Thus, taking the left node of the second level and splitting it at SP2 using Table A, the lower sub range and upper sub range of that node become:
lower sub-range (LSR)=LB . . . min (SP2,SP1-1,UB) [9]
upper sub-range (USR)=max (SP2+1,LB) . . . min (SP1-1,UB) [10]
Furthermore, based on Table A, the right edge is marked as a “then” (T) case, and the left edge is marked as an “else” (E) case. In [9] and [10], it will be seen that “min (SP1-1,UB)” has now become the “UB” of [1] and [2], above, but [9] and [10] are otherwise expressed in the form for the “i>SP” condition operator.

Similarly, taking the right node of the second level and splitting it at SP2, the lower sub range and upper sub range of that node become:
lower sub-range (LSR)=max (SP1,LB) . . . min (SP2,UB) [11]
upper sub-range (USR)=max (SP2+1,SP1,LB) . . . UB [12]
Furthermore, based on Table A, the left edge is marked as an “else” (E) case, and the right edge is marked as an “then” (T) case. In [11] and [12], it will be seen that “max (SP1,LB)” has now become the “LB” of [1] and [2], above, but [11] and [12] are otherwise expressed in the form for the “i>SP” condition operator.

The resulting sub-range tree shown in FIG. 6C may then be used for path-from-root analysis for each leaf node, in order to fold any dead inductive control flow branches, as will be explained further below.

The simplified algorithm shown in FIG. 5 illustrates but one possible process for the construction of the sub-range tree shown in FIGS. 6A-6C. It will be appreciated, however, that method 500 may be readily modified to take into account the different condition operators (as shown in Table A above) and the possibility of creating three sub-ranges for the special equality or non-equality conditions with the “==” or “!=” condition operators. More specifically, the condition operator will determine the number of inductive control flow branches, the split point adjustment, and the then/else ordering as follows:

If the condition operator is less than (i.e. “i<SP”), then:
LSR=LB . . . min (SP-1,UB);
USR=max (SP,LB) . . . UB;

The edge to LSR is marked T, and the edge to USR is marked E.

If the condition operator is less than or equal to (i.e. “i<=SP”), then:
LSR=LB . . . min (SP,UB);
USR=max (SP+1,LB) . . . UB;

The edge to LSR is marked T, and the edge to USR is marked E.

If the condition operator is greater than (i.e. “i>SP”), then:
LSR=LB . . . min (SP,UB);
USR=max (SP+1,LB) . . . UB;

The edge to LSR is marked E, and the edge to USR is marked T.

If the condition operator is greater than or equal to (i.e. “i>=SP”), then:
LSR=LB . . . min (SP-1,UB);
USR=max (SP,LB) . . . UB;

The edge to LSR is marked E, and the edge to USR is marked T.

If the condition operator is equal to (i.e “i==SP”), then:
LSR=LB . . . min (SP-1,UB);
ESR=max (SP,LB) . . . min (SP,UB);
USR=max (SP+1,LB) . . . UB;

The edge to LSR is marked E, the edge to ESR is marked T, and the edge to USR is marked E.

If the condition operator is not equal to (i.e. “i!=SP”), then:
LSR=LB . . . min (SP-1,UB);
ESR=max (SP,LB) . . . min (SP,UB);
USR=max (SP+1,LB) . . . UB;

The edge to LSR is marked T, the edge to ESR is marked E, and the edge to USR is marked T.

As will be illustrated further below, once the edges in the sub-range tree have been marked with a “T” and “E”, it is known which inductive control flow branches are dead for any “leaf node” for which a loop is to be generated. No further analysis is needed.

When generating software loop code from a sub-range tree, “dead” inductive control flow branches can be folded into either a “NO-OP” (no operation) if it is known that the condition will always fail, or an “ALWAYS-JUMP” or “TRUE-JUMP” if it is known that the condition will always succeed. The “dead” code may then be eliminated, for example, by using a well known optimization technique known as “dead-code elimination”. For more information on dead-code elimination, the reader is directed to one of many references available, including “Building an Optimizing Compiler” by Robert Morgan, pp. 219-222, ISBN 1-55558-179-X, published by “Digital Press”.

Referring back to FIG. 6C, in the general case, given a lower bound LB, an upper bound UB, and a set of unknown split points SP1,SP2, . . . SPn, the resulting sub-range tree is a full tree (i.e. no pruning of edges and nodes is involved), since it is not possible to determine the “emptiness” of sub-ranges at compile time. However, given a powerful enough symbolic expression simplifier, a number of these relationships can be determined at compile time, possibly resulting in more efficient code.

Using a Sub-Range Tree in Generating the Index-Set-Split Loops

Given a sub-range tree, the sub-ranges can be collected at the leaf nodes in a left-to-right order (an arbitrarily chosen convention) to get the set of (LB, UB) pairs for generating the index-set split loops.

As an illustrative example, consider the following code which contains two inductive control flow branches (as defined by the two condition operators “if (i<5)” and ”if (i>20)”):

do i=1, 100

a[i] = a[i]+1
if (i < 5) then

a[i] = 2*a[i]

end if
if (i > 20) then

a[i] = 5*a[i]

else

a[i] = 3*a[i]

end if

end do

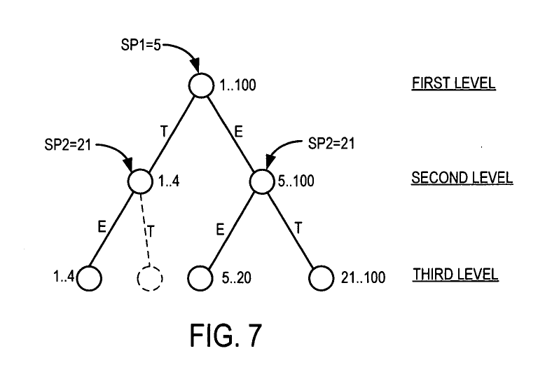

It will be observed that the generalized form of the sub-range tree illustrated in FIGS. 6A-6C can apply in this case, since the two condition operators are of the form “i<SP1” and “i>SP2”. Here, the split points are SP1=5 for the first condition, and SP2=21 for the second. Following the illustrative example in FIGS. 6A-6C, constructing the sub-range tree for the above example based on method 500 will result in the sub-range tree illustrated in FIG. 7. As will be apparent, the sub-range tree in FIG. 7 has the following features:
Split points are computed, and adjusted as necessary, according to the conditional operators in the inductive control flow branches (using Table A, above).
The edges of the tree are marked with a “T” or “E”, indicating a “then” part or an “else” part, respectively (again using Table A, above).
Dead inductive control flow branches (and the sections of the loop controlled by those inductive control flow branches) are folded where possible.

Applying this to the illustrative example shown in FIG. 7, the sub-ranges would be 1 . . . 4, 5 . . . 20, and 21 . . . 100, and the resulting code would be as follows:

do i=1, 4

a[i] = a[i]+1
if (i < 5) then

a[i] = 2*a[i]

end if
if (i > 20) then

a[i] = 5*a[i]

else

a[i] = 3*a[i]

end if

end do
do i=5, 20

a[i] = a[i]+1
if (i < 5) then

a[i] = 2*a[i]

end if
if (i > 20) then

a[i] = 5*a[i]

else

a[i] = 3*a[i]

end if

end do
do i=21, 100

a[i] = a[i]+1
if (i < 5) then

a[i] = 2*a[i]

end if
if (i > 20) then

a[i] = 5*a[i]

else

a[i] = 3*a[i]

end if

end do

Removing “dead” Inductive Control Flow Branches in the Original Loop

As explained earlier, the “T” and “E” markings on the edges of the sub-range tree in FIG. 7, may be used to remove dead inductive control flow branches. More specifically, a “path-from-root” can be computed for each sub-range (i.e. the path from the root node of the tree to each leaf node representing a sub-range). The inductive conditions along the path and the edge markings (i.e. “then” or “else”) are recorded. For each “path-from-root” to a sub-range represented by a leaf node, it is known which inductive conditions from the original loop were selected to reach that leaf node. Consequently, certain inductive control flow branches of the original loop can be identified as being always true or always false, in a loop generated for the sub-range.

Applying this approach to the example in FIG. 7 provided above, the collected sub-ranges and the inductive control flow branch selections would be:
sub-range: 1 . . . 4, path-from-root: (i<5, T), (i>20, E)
sub-range: 5 . . . 20, path-from-root: (i<5, E), (i>20, E)
sub-range: 21 . . . 100, path-from-root: (i<5, E), (i>20, T)

The resulting code, with the dead inductive control flow branches folded (knowing the “then” and “else” selections), would be as follows:

do i=1, 4

a[i] = a[i]+1
a[i] = 2*a[i]
a[i] = 3*a[i]

end do
do i=5, 20

a[i] = a[i]+1
a[i] = 3*a[i]

end do
do i=21, 100

a[i] = a[i]+1
a[i] = 5*a[i]

end do

### A GENERIC EXAMPLE

In a general case, as previously shown in FIGS. 6A-6C, substantially the same technique can be applied with a similar result. For example, consider the following software loop code (corresponding to a general case of the example shown in FIG. 7):

do i=LB, UB

a[i] = a[i]+1
if (i < SP1) then

a[i] = 2*a[i]

end if
if (i > SP2) then

a[i] = 5*a[i]

else

a[i] = 3*a[i]

end if

end do

Applying [9], [10], [11] and [12], to calculate the sub-ranges for each node in the third level, and following a path-from-root, the following results are obtained:
sub-range: LB . . . min (SP2,SP1-1,UB); path-from-root: (i<SP1,T), (i>SP2,E)
sub-range: max (SP2+1,LB) . . . min (SP1-1,UB); path-from-root: (i<SP1,T), (i>SP2,T)
sub-range: max (SP1,LB) . . . min (SP2,UB); path-from-root: (i<SP1,E), (i>SP2,E)
sub-range: max (SP2+1,SP1,LB) . . . UB; path-from-root: (i<SP1,E), (i>SP2,T)

The resulting code, after generating the loops and folding dead inductive control flow branches based on the T and E markings, would be as follows:

do i=LB, min(SP2,SP1−1,UB)

a[i] = a[i]+1
a[i] = 2*a[i]
a[i] = 3*a[i]

end do
do i=max(SP2+1,LB), min(SP1−1,UB)

a[i] = a[i]+1
a[i] = 2*a[i]
a[i] = 5*a[i]

end do
do i=max(SP1,LB), min(SP2,UB)

a[i] = a[i]+1
a[i] = 3*a[i]

end do
do i=max(SP2+1,SP1,LB), UB

a[i] = a[i]+1
a[i] = 5*a[i]

end do

It will be observed that, in the above generalized example, dead inductive control flow branches in each sub-range loop have been removed without having specific values for any of the variables LB, UB, SP1 and SP2. Four loops have been generated since the relationship between SP1 and SP2 is not known at compile time, and both cases “SP1>SP2” and “SP2>SP1” need to be supported. However, once this relationship is known at run time, at most three of the loops will get executed. More specifically, it will be seen that if SP2>SP1, then the second loop won't be executed; otherwise, if SP1>SP2, the third loop won't be executed. In the previous example in FIG. 7, as SP2>SP1, the second loop above is not executed.

Nested Inductive Control Flow Branches

Nested inductive control flow branches may be handled using the same sub-range tree approach. However, instead of propagating the split point down the entire sub-range tree (as done with un-nested inductive control flow branches, above), nested split points may be propagated only down the relevant paths in the tree. For example, referring back to FIG. 6C, if a nested inductive control flow branch “IB1” is located in the “then” part of an inductive control flow branch “IB2”, then the split point SP1 will not be propagated down the “else” sub-tree of the node associated with IB2. As will be appreciated, this leads to smaller trees and a smaller number of generated loops.

By way of illustration, consider the following code:

do i=LB, UB

if (i < SP1) then

a[i] = a[i]−1

else

if (i < SP2) then

a[i] = a[i]*2

else

a[i] = a[i]−2

end if

end if

end do

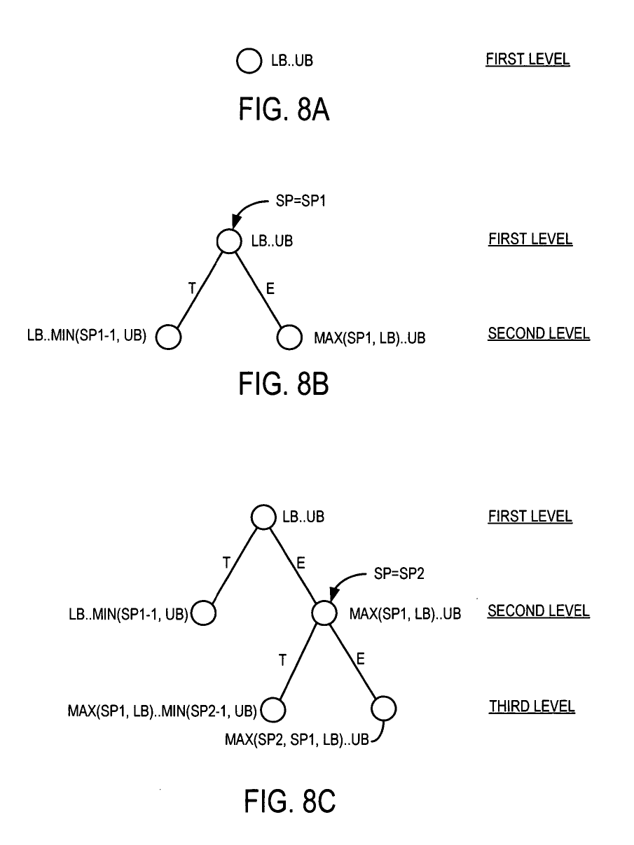

The sub-range tree for this code can be constructed as in FIGS. 8A-8C. As shown, propagating the split point SP2 follows only the “else” edge of the root node, since the nested inductive control flow branch is in the “else” part.

The resulting code, after collecting the sub-ranges and removing “dead” inductive control flow branches, is as follows:

do i=LB, min(SP1−1,UB)

a[i] = a[i]−1

end do
do i=max(SP1,LB), min(SP2−1,UB)

a[i] = a[i]*2

end do
do i=max(SP2,SP1,LB), UB

a[i] = a[i]−2

end do

There is no particular ordering requirement when processing split points and propagating them down the sub-range tree. However, it will be appreciated that nested inductive control flow branches should be processed after the inductive control flow branches nesting them, since this leads to smaller sub-range trees and a smaller number of generated loops.

Controlling Code Growth

While removing “dead” inductive control flow branches may significantly reduce the size of the generated code, the number of generated sub-range loops may still be too large for efficient execution. Consequently, it may be desirable to control growth of the code by applying a control limit.

In order to control code growth of generated sub-rage loops, it is first necessary to be able to estimate the potential code growth for every inductive control flow branch. In an embodiment, this estimation may be done by augmenting the sub-range tree with additional information, such as code “size”. Here, the code size may be, for example, the amount of memory consumed by the code during execution. Each node of the sub-range tree may be marked with such a code size.

In an embodiment, the root of a sub-range tree, which represents the range of the original loop, is marked with the code size estimate for the entire loop. Every node in the tree that is not a leaf node may further split the node's sub-range in up to three parts (e.g. in the case of an equality or non-equality split point, three sub-ranges are needed, as previously discussed). In each case, there may be code that will not be executed, since one of the inductive control flow branches may become dead or non-conditional. In this case, it is possible to estimate the sizes of the resulting loops at each of the nodes by subtracting the size of the non-executed code. Thus, the code size for a particular sub-node may be estimated using the parent node's code size, and the code sizes at each sub-node.

Once the code size estimates have been computed for each potentially generated loop, it is possible to apply a heuristic that will decide which loops to generate. This heuristic may be viewed as a method of deciding which nodes in the sub-range tree to mark as a “leaf node” (although there could be descendant sub-nodes under that “leaf node” otherwise). In an embodiment, this can be done by marking all the nodes in the sub-range tree as “locked” or “unlocked”. This allows the root node and any of its sub-nodes to be marked as leaf nodes during the code generation process. Initially, as far as the code generation algorithm is concerned, the tree begins and ends at a “locked” root node. The code sizes of the root node's direct descendants are then examined. If the sum of the code sizes of the root node's direct descendants is less than the chosen code growth limit, then the root node is marked as “locked”. A suitable code generation method, such as that illustrated above in FIG. 5, may then generate loops according to the sub-ranges represented by each “leaf node” of the sub-range tree (i.e., by each direct descendant node of the root node). Each descendant node may then be “unlocked” in a “greedy breadth-first” manner (in which breadth of coverage is preferred over depth) until the growth limit is reached, or until all non-leaf node nodes have been marked “unlocked”.

By making use of the heuristic described above, it will be understood that a growth constraint can be enforced on the sub-range tree. Advantageously, sub-range loops may be generated simply by reading, in a left-to-right order, the sub-ranges corresponding to each leaf node (i.e., either a true leaf node or a “locked” node) in the sub-range tree.

While various embodiments of the invention have been described above, it will be appreciated by those skilled in the art that variations and modifications may be made without departing from the scope of the invention, which is defined by the following claims.

1. A method of determining the sub-range bounds of a software loop having a lower bound (LB), an upper bound (UB), and a split point (SP) associated with an inductive control flow branch and a condition operator, said method comprising:
(i) defining, in dependence upon said condition operator, a lower sub-range (LSR) as a function of said LB, UB and SP;
(ii) if said condition operator is one of an equality operator (==) or a non-equality operator (!=), then defining an equality sub-range (ESR) as a function of said LB, UB and SP;
(iii) defining, in dependence upon said condition operator, an upper sub-range (USR) as a function of said LB, UB and SP.

2. The method of claim 1, further comprising logically representing said software loop as a node of a sub-range tree having a range LB . . . UB, and logically representing said LSR, ESR if any, and USR, as descendant nodes attached by edges to said root node.

3. The method of claim 2, wherein one of a “then” (T) and an “else” (E) marker is used to logically mark each edge, and wherein said SP is adjusted, according to the following:

| Condition | Split Point | Then (T)/Else (E) |
|---|---|---|
| Operator | Adjustment | Ordering |
| i < SP | SP | T, E |
| i <= SP | SP + 1 | T, E |
| i > SP | SP + 1 | E, T |
| i >= SP | SP | E, T |
| i == SP | SP | E, T, E |
| i != SP | SP | T, E, T |

where i is an induction variable of said software loop.

4. The method of claim 2, wherein said condition operator is less than (i<SP), and said method comprises:
defining said LSR as LB . . . min (SP-1,UB);
defining said USR as max (LB,SP) . . . UB;
marking an edge to said LSR as T, and marking an edge to said USR as E.

5. The method of claim 2, wherein said condition operator is less than or equal to (i<=SP), and said method comprises:
defining said LSR as LB . . . min (SP,UB);
defining said USR as max (LB,SP+1) . . . UB;
marking an edge to said LSR as T, and marking an edge to said USR as E.

6. The method of claim 2, wherein said condition operator is greater than (i>SP), and said method comprises:
defining said LSR as LB . . . min (SP,UB);
defining said USR as max (SP+1,LB) . . . UB;
marking an edge to said LSR as E, and marking an edge to said USR as T.

7. The method of claim 2, wherein said condition operator is greater than or equal to (i>=SP), and said method comprises:
defining said LSR as LB . . . min (SP-1,UB);
defining said USR as max (SP,LB) . . . UB;
marking an edge to said LSR as E, and marking an edge to said USR as T.

8. The method of claim 2, wherein said condition operator is equal to (i==SP), and said method comprises:
defining said LSR as LB . . . min (SP-1,UB);
defining said ESR as max (SP,LB) . . . min (SP,UB);
defining said USR as max (SP+1,LB) . . . UB;
marking an edge to said LSR as E, marking an edge to said ESR as T, and marking an edge to said USR as E.

9. The method of claim 2, wherein said condition operator is not equal to (i!=SP), and said method comprises:
defining said LSR as LB . . . min (SP-1,UB);
defining said ESR as max (SP,LB) . . . min (SP,UB);
defining said USR as max (SP+1,LB) . . . UB;
marking an edge to said LSR as T, marking an edge to said ESR as E, and marking an edge to said USR as T.

10. The method of claim 2, further comprising:
(iv) analyzing a path-from-root for each leaf node of said sub-range tree to determine whether an inductive control flow branch is always true or always false;
(v) for each node in (iv) determined as having an inductive control flow branch that is always true or always false, folding said inductive control flow branch.

11. The method of claim 10, further comprising generating sub-range loop code for sub-ranges represented by remaining leaf nodes of said sub-range tree.

12. The method of claim 11, further comprising controlling growth of said sub-range loop code by applying a predetermined sub-range loop code growth limit to each node of said sub-range tree.

13. The method of claim 12, wherein said predetermined sub-range loop code growth limit is a code size estimated as the amount of memory consumed by the code during execution.

14. The method of claim 3, wherein each node of said sub-range tree is generally defined by the following expression:
L=(LB′, UB′, ((LB′, min (SPj-1, UB′), ( . . . )), (max (SPj, LB′), UB′, ( . . . ))))
where SPj is a split point j, LB′ and UB′ are a lower bound and upper bound for a particular sub-range represented by node L, (LB′, min (SPj, UB′), ( . . . )) represents a first sub-range expressed by LB′, UB′ and SPj, (max (SPj, LB′), UB′, ( . . . )) represents a second sub-range represented by LB′, UB′ and SPj, and the brackets ( . . . ) represent zero or more descendant sub-nodes.

15. A system for determining the sub-range bounds of a software loop having a lower bound (LB), an upper bound (UB), and a split point (SP) associated with an inductive control flow branch and a condition operator, said system comprising:
(a) means for defining, in dependence upon said condition operator, a lower sub-range (LSR) as a function of said LB, UB and SP;
(b) means for defining, if said condition operator is one of an equality operator (==) or a non-equality operator (!=), an equality sub-range (ESR) as a function of said LB, UB and SP;
(c) means for defining, in dependence upon said condition operator, an upper sub-range (USR) as a function of said LB, UB and SP.

16. The system of claim 15, further comprising means for logically representing said software loop as a node of a sub-range tree having a range LB . . . UB, and logically representing said LSR, ESR if any, and USR, as descendant nodes attached by edges to said root node.

17. The system of claim 16, further comprising means for logically marking one of a “then” (T) and an “else” (E) marker on each edge, and for adjusting said SP, according to the following:

| Condition | Split Point | Then (T)/Else (E) |
|---|---|---|
| Operator | Adjustment | Ordering |
| i < SP | SP | T, E |
| i <= SP | SP + 1 | T, E |
| i > SP | SP + 1 | E, T |
| i >= SP | SP | E, T |
| i == SP | SP | E, T, E |
| i != SP | SP | T, E, T |

where i is an induction variable of said software loop.

18. The system of claim 16, wherein said condition operator is less than (i<SP), and said system comprises means for:
defining said LSR as LB . . . min (SP-1,UB);
defining said USR as max (LB,SP) . . . UB;
marking an edge to said LSR as T, and marking an edge to said USR as E.

19. The system of claim 16, wherein said condition operator is less than or equal to (i<=SP), and said system comprises means for:
defining said LSR as LB . . . min (SP,UB);
defining said USR as max (LB,SP+1) . . . UB;
marking an edge to said LSR as T, and marking an edge to said USR as E.

20. The system of claim 16, wherein said condition operator is greater than (i>SP), and said system comprises means for:
defining said LSR as LB . . . min (SP,UB);
defining said USR as max (SP+1,LB) . . . UB;
marking an edge to said LSR as E, and marking an edge to said USR as T.

21. The system of claim 16, wherein said condition operator is greater than or equal to (i>=SP), and said system comprises means for:
defining said LSR as LB . . . min (SP-1,UB);
defining said USR as max (SP,LB) . . . UB;
marking an edge to said LSR as E, and marking an edge to said USR as T.

22. The system of claim 16, wherein said condition operator is equal to (i==SP), and said system comprises means for:
defining said LSR as LB . . . min (SP-1,UB);
defining said ESR as max (SP,LB) . . . min (SP,UB);
defining said USR as max (SP+1,LB) . . . UB;
marking an edge to said LSR as E, marking an edge to said ESR as T, and marking an edge to said USR as E.

23. The system of claim 16, wherein said condition operator is not equal to (i!=SP), and said system comprises means for:
defining said LSR as LB . . . min (SP-1,UB);
defining said ESR as max (SP,LB) . . . min (SP,UB);
defining said USR as max (SP+1,LB) . . . UB;
marking an edge to said LSR as T, marking an edge to said ESR as E, and marking an edge to said USR as T.

24. The system of claim 16, further comprising:
(d) means for analyzing a path-from-root for each leaf node of said sub-range tree to determine whether an inductive control flow branch is always true or always false;
(e) means for folding an inductive control flow branch determined in (d) as being always true or always false.

25. The system of claim 24, further comprising means for generating sub-range loop code for sub-ranges represented by remaining leaf nodes of said sub-range tree.

26. The system of claim 25, further comprising means for controlling growth of said sub-range loop code by applying a predetermined sub-range loop code growth limit to each node of said sub-range tree.

27. The system of claim 26, wherein said predetermined sub-range loop code growth limit is a code size estimated as the amount of memory consumed by the code during execution.

28. The system of claim 17, wherein said system includes means for defining each leaf node of said sub-range tree by the following expression:
L=(LB′, UB′, ((LB′, min (SPj-1, UB′), ( . . . )), (max (SPj, LB′), UB′, ( . . . ))))
where SPj is a split point j, LB′ and UB′ are a lower bound and upper bound for a particular sub-range represented by node L, (LB′, min (SPj, UB′), ( . . . )) represents a first sub-range expressed by LB′, UB′ and SPj, (max (SPj, LB′), UB′, ( . . . )) represents a second sub-range represented by LB′, UB′ and SPj, and the brackets ( . . . ) represent zero or more descendant sub-nodes.

29. A computer readable medium storing computer executable code for determining the sub-range bounds of a software loop having a lower bound (LB), an upper bound (UB), and a split point (SP) associated with an inductive control flow branch and a condition operator, said computer executable code comprising:
(a) code for defining, in dependence upon said condition operator, a lower sub-range (LSR) as a function of said LB, UB and SP;
(b) code for determining if said condition operator is one of an equality operator (==) or a non-equality operator (!=), and if so, for defining an equality sub-range (ESR) as a function of said LB, UB and SP;
(c) code for defining, in dependence upon said condition operator, an upper sub-range (USR) as a function of said LB, UB and SP.

30. The computer readable medium of claim 29, further comprising code for logically representing said software loop as a node of a sub-range tree having a range LB . . . UB, and logically representing said LSR, ESR if any, and USR, as descendant nodes attached by edges to said root node.

31. The computer readable medium of claim 30, further comprising code for logically marking one of a “then” (T) and an “else” (E) marker on each edge, and for adjusting said SP, according to the following:

| Condition | Split Point | Then (T)/Else (E) |
|---|---|---|
| Operator | Adjustment | Ordering |
| i < SP | SP | T, E |
| i <= SP | SP + 1 | T, E |
| i > SP | SP + 1 | E, T |
| i >= SP | SP | E, T |
| i == SP | SP | E, T, E |
| i != SP | SP | T, E, T |

where i is an induction variable of said software loop.

32. The computer readable medium of claim 30, wherein said condition operator is less than (i<SP), and said computer executable code further comprises code for:
defining said LSR as LB . . . min (SP-1,UB);
defining said USR as max (LB,SP) . . . UB;
marking an edge to said LSR as T, and marking an edge to said USR as E.

33. The computer readable medium of claim 30, wherein said condition operator is less than or equal to (i<=SP), and said computer executable code further comprises code for:
defining said LSR as LB . . . min (SP,UB);
defining said USR as max (LB,SP+1) . . . UB;
marking an edge to said LSR as T, and marking an edge to said USR as E.

34. The computer readable medium of claim 30, wherein said condition operator is greater than (i>SP), and said computer executable code further comprises code for:
defining said LSR as LB . . . min (SP,UB);
defining said USR as max (SP+1,LB) . . . UB;
marking an edge to said LSR as E, and marking an edge to said USR as T.

35. The computer readable medium of claim 30, wherein said condition operator is greater than or equal to (i>=SP), and said computer executable code further comprises code for:
defining said LSR as LB . . . min (SP-1,UB);
defining said USR as max (SP,LB) . . . UB;
marking an edge to said LSR as E, and marking an edge to said USR as T.

36. The computer readable medium of claim 30, wherein said condition operator is equal to (i==SP), and said computer executable code further comprises code for:
defining said LSR as LB . . . min (SP-1,UB);
defining said ESR as max (SP,LB) . . . min (SP,UB);
defining said USR as max (SP+1 ,LB) . . . UB;
marking an edge to said LSR as E, marking an edge to said ESR as T, and marking an edge to said USR as E.

37. The computer readable medium of claim 30, wherein said condition operator is not equal to (i!=SP), and said computer executable code further comprises code for:
defining said LSR as LB . . . min (SP-1,UB);
defining said ESR as max (SP,LB) . . . min (SP,UB);
defining said USR as max (SP+1,LB) . . . UB;
marking an edge to said LSR as T, marking an edge to said ESR as E, and marking an edge to said USR as T.

38. The computer readable medium of claim 30, further comprising:
(d) code for analyzing a path-from-root for each leaf node of said sub-range tree to determine whether an inductive control flow branch is always true or always false;
(e) code for folding an inductive control flow branch determined in (d) as being always true or always false.

39. The computer readable medium of claim 38, further comprising code for generating sub-range loop code for sub-ranges represented by remaining leaf nodes of said sub-range tree.

40. The computer readable medium of claim 39, further comprising code for controlling growth of said sub-range loop code by applying a predetermined sub-range loop code growth limit to each node of said sub-range tree.

41. The computer readable medium of claim 40, wherein said predetermined sub-range loop code growth limit is a code size estimated as the amount of memory consumed by the code during execution.

42. The computer readable medium of claim 31, wherein said computer executable code further includes code for defining each leaf node of said sub-range tree by the following expression:
L=(LB′, UB′, ((LB′, min (SPj-1, UB′), ( . . . )), (max (SPj, LB′), UB′, ( . . . ))))
where SPj is a split point j, LB′ and UB′ are a lower bound and upper bound for a particular sub-range represented by node L, (LB′, min (SPj, UB′), ( . . . )) represents a first sub-range expressed by LB′, UB′ and SPj, (max (SPj, LB′), UB′, ( . . . )) represents a second sub-range represented by LB′, UB′ and SPj, and the brackets ( . . . ) represent zero or more descendant sub-nodes.
